(19) United States
(12) Patent Application Publication
(10) Pub. No.: US 2013/0191279 A1
(43) Pub. Date: Jul. 25, 2013

(54) MOBILE DEVICE WITH REWRITABLE GENERAL PURPOSE CARD

(71) Applicants: Matthew A. CALMAN, Charlotte, NC (US); Erik Stephen Ross, Charlotte, NC (US)

(72) Inventors: Matthew A. CALMAN, Charlotte, NC (US); Erik Stephen Ross, Charlotte, NC (US)

(73) Assignee: Bank of America Corporation, Charlotte, NC (US)

(21) Appl. No.: 13/355,274

(22) Filed: Jan. 20, 2012

(51) Int. Cl. G06Q 20/36; G06Q 20/32

(52) U.S. Cl. 705/41

(57) ABSTRACT

A mobile device with a rewritable general purpose card is disclosed. The mobile device includes a mobile wallet accessible to the user such that the user may select a payment vehicle (e.g., debit card, credit card, gift card, etc.) or other vehicle (e.g., merchant loyalty cards, membership cards, rewards cards, medical cards, insurance cards, identification cards, etc.) and encode data related to that vehicle to the rewritable general purpose card. The user may then utilize the encoded general purpose card to make a transaction. Generally, the general purpose card includes one or more displays which may be configured to display information, graphics, data, etc. (e.g. account number, expiration date, user identification such as name and/or photograph, card brand logo, bar codes or other codes readable to an electronic device, etc.).

### BACKGROUND

In today's “digital age,” more and more processes are becoming digital or automated. This is especially true in the financial industry. Over the years, primary methods for payment have evolved from cash to checks to credit and debit cards. More recently, technology has become available that permits for “contactless” transactions. For instance, a contactless payment is a payment where a customer pays a purchase amount without handing a payment card or a payment device to a cashier at the point-of-sale (POS) and without swiping the magnetic stripe of a payment card through a payment terminal (also sometimes referred to as a POS terminal). In other words, a contactless payment is one made using a payment device that may wirelessly transmit payment information to the payment terminal. Although physical contact between the payment device and the payment terminal may still occur in a contactless payment environment, physical contact between the payment device and the payment terminal is not necessary for transmission of the payment information from the payment device to the payment terminal.

Many payment terminals have the ability to read and process electronic payment information such as credit card or debit card information received wirelessly from a mobile device (e.g., a cell phone or other handheld computer) that is brought close to the payment terminal. Mobile devices configured with contactless transaction technology are often referred to as “mobile wallets” or “electronic wallets.”

A mobile device having mobile wallet capabilities may allow a user to use the mobile device's interface to select a payment vehicle that the user wishes to use for paying a purchase amount. Subsequently, the mobile device may transmit payment information associated with the selected payment vehicle when the mobile device is brought close to the payment terminal. A payment vehicle may be any payment instrument such as a credit account, debit account, bank card, or other instrument that can be used by one entity to pay another entity.

One drawback to mobile wallets is the inability for a mobile wallet to interface with a POS terminal, automated teller machine (ATM), etc. that is incapable of contactless transactions. As such, users of mobile wallets usually must continue to carry the physical card associated with each account in the mobile wallet for instances in which “contact” methods are the only acceptable methods.

iCache Inc. of Cambridge, Mass. markets a mobile device capable of writing individual card data from a mobile wallet to a magnetic stripe of a general purpose card that the user may extract and utilize at a POS terminal. The iCache device is described in U.S. Patent Application Publication No. 2008/0059379, which is incorporated herein in its entirety. One shortcoming of the iCache design, however, is that the card is completely generic on the face, which could very easily lead to questions of potential fraud. For example, if a clerk wishes to see the card to verify the last 4-digits, the CVC/CVC2 code, etc., the data will not be visible and only obtainable from the data written on the magnetic stripe. The general purpose card may be preprinted with a customer's name and/or other “general” data, however there is not a way to indicate that at one time, the card is a Visa® debit card, another a MasterCard® credit card, another an American Express charge card®, etc.

### SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the present invention address the above needs and/or achieve other advantages by providing an apparatus (e.g., a system, computer program product, and/or other device), method, or a combination of the foregoing for making a transaction via a mobile device. Particularly, embodiments of the present invention are directed to a mobile device with a rewritable general purpose card. The mobile device includes a mobile wallet accessible to the user such that the user may select a payment vehicle (e.g., debit card, credit card, gift card, etc.) or other vehicle (e.g., merchant loyalty cards, membership cards, rewards cards, medical cards, insurance cards, identification cards, etc.) and encode data related to that vehicle to the rewritable general purpose card. The user may then utilize the encoded general purpose card to make a transaction. Generally, the general purpose card includes one or more displays which may be configured to display information, graphics, data, etc. (e.g. account number, expiration date, user identification such as name and/or photograph, card brand logo, bar codes or other codes readable to an electronic device, etc.).

In a first aspect of the invention, a mobile device is provided. The mobile device includes a memory device, a user interface configured to present information to a user, and a processing device operatively coupled to the memory device and the user interface. The processing device is configured to execute computer-readable program code to display, via the user interface, one or more vehicles in a mobile wallet such that the one or more vehicles are selectable to the user, receive a vehicle selection from the user, encode data related to the selected vehicle onto a magnetic stripe of a general purpose card, and program one or more electronic displays on the general purpose card to display information related to the selected vehicle.

In some embodiments, the mobile device further includes a general purpose card interface that houses the general purpose card. The general purpose card interface includes a magnetic stripe encoder for encoding the data onto the magnetic stripe of the general purpose card and an electronic display encoder for programing the one or more displays of the general purpose card. In some embodiments, the electronic displays are persistent displays such as, in one embodiment, electronic ink displays. In some embodiments, the card is configured such that a power source is not required. In some embodiments, the mobile device further includes a biometric security device.

In some embodiments of the mobile device, the processing device is further configured to execute computer-readable program code to reset the general purpose card erasing magnetic data encoded on the magnetic stripe and altering the one or more electronic displays. In some such embodiments, the resetting of the general purpose card is completed upon returning of the general purpose card to the mobile device.

In some embodiments of the mobile device, the one or more vehicles include payment vehicles such as credit cards, debit cards, gift cards, etc. In some embodiments, the one or more vehicles comprise non-payment vehicles such as merchant loyalty cards, membership cards, rewards cards, medical cards, insurance cards, and identification cards.

In another aspect of the invention, a method is provided. The method includes executing, by a processing device of a mobile device, a mobile wallet including one or more vehicles selectable to a user. The method further includes encoding data related to a selected vehicle onto a magnetic stripe of a general purpose card. Additionally, the method includes programming one or more electronic displays on the general purpose card to display information related to the selected vehicle.

In some embodiments of the method, the mobile device includes a general purpose card interface that houses the general purpose card. The general purpose card interface includes a magnetic stripe encoder for encoding the data onto the magnetic stripe of the general purpose card and an electronic display encoder for programing the one or more displays of the general purpose card. In some embodiments, the electronic displays are persistent displays such as, in one embodiment, electronic ink displays.

In some embodiments, the method further includes resetting the general purpose card erasing magnetic data encoded on the magnetic stripe and altering the one or more electronic displays.

In some embodiments of the method, the one or more vehicles include payment vehicles such as credit cards, debit cards, gift cards, etc. In some embodiments, the one or more vehicles comprise non-payment vehicles such as merchant loyalty cards, membership cards, rewards cards, medical cards, insurance cards, and identification cards.

In another aspect of the invention, a method for making a transaction is provided. The method includes selecting a vehicle from a mobile wallet of a mobile device. Upon selecting the vehicle, the mobile device encodes data related to the selected vehicle onto a magnetic stripe of a general purpose card and programs one or more electronic displays on the general purpose card to display information related to the selected vehicle. The method further includes removing the general purpose card from the mobile device. Additionally, the method includes utilizing the general purpose card to make a transaction. The method further includes returning the general purpose card to the mobile device.

In some embodiments of the method, the mobile device includes a general purpose card interface that houses the general purpose card. The general purpose card interface includes a magnetic stripe encoder for encoding the data onto the magnetic stripe of the general purpose card and an electronic display encoder for programing the one or more displays of the general purpose card. In some embodiments, the electronic displays are persistent displays such as, in one embodiment, electronic ink displays.

In some embodiments of the method, the one or more vehicles include payment vehicles such as credit cards, debit cards, gift cards, etc. In some embodiments, the one or more vehicles comprise non-payment vehicles such as merchant loyalty cards, membership cards, rewards cards, medical cards, insurance cards, and identification cards.

In another aspect of the invention, a computer program product is provided. The computer program product includes a non-transitory computer-readable medium that includes instructions for a processing device of a mobile device to execute a mobile wallet application that includes one or more vehicles selectable to the user. The product further includes instructions for encoding data related to a selected vehicle onto a magnetic stripe of a general purpose card. Additionally, the product includes instructions for programming one or more electronic displays on the general purpose card to display information related to the selected vehicle.

In some embodiments of the computer program product, the mobile device includes a general purpose card interface that houses the general purpose card. The general purpose card interface includes a magnetic stripe encoder for encoding the data onto the magnetic stripe of the general purpose card and an electronic display encoder for programing the one or more displays of the general purpose card. In some embodiments, the electronic displays are persistent displays such as, in one embodiment, electronic ink displays.

In some embodiments of the method, the one or more vehicles include payment vehicles such as credit cards, debit cards, gift cards, etc. In some embodiments, the one or more vehicles comprise non-payment vehicles such as merchant loyalty cards, membership cards, rewards cards, medical cards, insurance cards, and identification cards.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 illustrates a block diagram illustrating a transaction environment, in accordance with an embodiment of the invention;

FIG. 2 illustrates a block diagram illustrating the mobile device of FIG. 1, in accordance with an embodiment of the invention;

FIG. 3 illustrates a block diagram illustrating a mobile wallet with a plurality of payment vehicles and other vehicles, in accordance with another embodiment of the invention;

FIGS. 4A-6B illustrate example embodiments of a general purpose card, in accordance with embodiments of the present invention;

FIG. 7 illustrates a mobile device display illustrating a selected payment vehicle, in accordance with an embodiment of the present invention;

FIGS. 8A and 8B illustrate profile views of a mobile device including a general purpose card interface, in accordance with embodiments of the present invention;

FIG. 9 is a high level flow diagram of a method for performing a transaction, in accordance with an embodiment of the present invention; and

FIG. 10 is a high level flow diagram of a method for writing/encoding a general purpose card, in accordance with an embodiment of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In accordance with embodiments of the invention, the term “entity” may refer to a seller, merchant, or the like, that offers contactless payment as a method of paying for a purchase associated with the entity. In accordance with embodiments of the invention, the term “user” may refer to a customer or the like, who utilizes the mobile device and/or general purpose card to conduct a transaction. In accordance with embodiments of the invention, the term “tapping” may refer to bringing a mobile device close to or within the proximity of a payment terminal so that information can be communicated wirelessly between the mobile device and the payment terminal using short range wireless transmission technology, such near-field communication (NFC) technology, radio-frequency (RF) technology, or the like. Tapping may include physically tapping the mobile device against an appropriate portion of the payment terminal or it may include only waving or holding the mobile device near an appropriate portion of the payment terminal without making physical contact with the payment terminal.

In accordance with embodiments of the invention, the term “payment vehicle” may refer to an electronic payment vehicle, such as an electronic credit or debit card including account identifying information stored electronically in a mobile device, such as in a cell phone. The term “other vehicles” may refer to vehicles that are not payment vehicles but may be beneficial to store on the mobile device in order to encode the general purpose card. For example, other vehicles include merchant loyalty cards, merchant membership cards, medical cards, etc. In accordance with embodiments of the invention, the term “module” with respect to an apparatus may refer to a hardware component of the apparatus, a software component of the apparatus, or a component of the apparatus that comprises both hardware and software. In accordance with embodiments of the invention, the term “chip” may refer to an integrated circuit, a microprocessor, a system-on-a-chip, a microcontroller, or the like that may either be integrated into the mobile device or may be inserted and removed from the mobile device by a user. In accordance with embodiments of the invention, the phrase “mobile wallet” refers to the hardware and/or software in a mobile device that stores payment vehicle and other vehicle data and enables the mobile device to be used to make contactless and/or encode a general purpose card to make contact transactions.

In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like.

In general, embodiments of the present invention relate to a mobile device with a rewritable general purpose card. The mobile device includes a mobile wallet accessible to the user such that the user may select a payment vehicle (e.g., debit card, credit card, gift card, etc.) or other vehicle (e.g., merchant loyalty cards, membership cards, rewards cards, medical cards, insurance cards, identification cards, etc.) and encode data related to that vehicle to the rewritable general purpose card. The user may then utilize the encoded general purpose card to make a transaction. Generally, the general purpose card includes one or more displays which may be configured to display information, graphics, data, etc. (e.g. account number, expiration date, user identification such as name and/or photograph, card brand logo, bar codes or other codes readable to an electronic device, etc.).

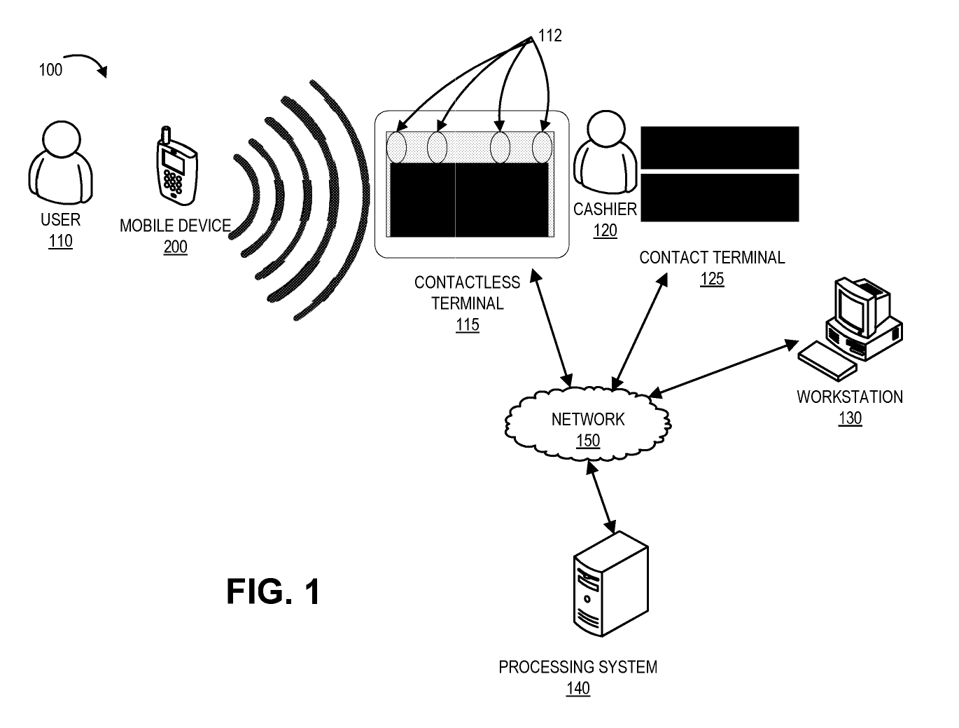

FIG. 1 provides a block diagram illustrating a transaction environment 100 configured for making a transaction via a mobile device utilizing a mobile wallet. As illustrated, the transaction environment 100 may include a mobile device 200 operable by a user 110 who may be a customer who wants to make a transaction via a mobile device 200. The transaction environment 100 may also include a contactless terminal 115 that may be automated or may be operable by a cashier 120. The contactless terminal 115 may permit a user to make a contactless payment or transaction with a transaction device such as the mobile device 200.

The environment 100 may also include a contact terminal 125 that may permit a user to make a payment or conduct other transactions via a contact transaction device such as a POS terminal, ATM, etc. Contact transactions are generally conducted using a card that has a magnetic stripe which may be swiped through the contact terminal 125 or other form of contact transaction, such as by a contact smart card.

The transaction environment 100 may also include a workstation 130 and a processing system 140 that are in electronic communication with the contactless terminal 115 and/or contact terminal 125 via a network 150, which may be the Internet, an intranet or the like. The user interface 112 situated on the contactless terminal may be any sort of device, such as a liquid crystal display (LCD) or light emitting diode (LED) display for indicating that payment has been received, invalid payment vehicle, exceeded credit limit, etc.

In FIG. 1, the network 150 may include a local area network (LAN), a wide area network (WAN), and/or a global area network (GAN). The network 150 may provide for wireline, wireless, or a combination of wireline and wireless communication between devices in the network. In some embodiments, the network 150 includes the Internet. In some embodiments, the network 150 may include a wireless telephone network.

The workstation 130 may be used by the cashier 120 or other personnel to interact with the contactless terminal 200. The workstation 130 may include various features, such as a network communication interface, a processing device, a user interface, and a memory device

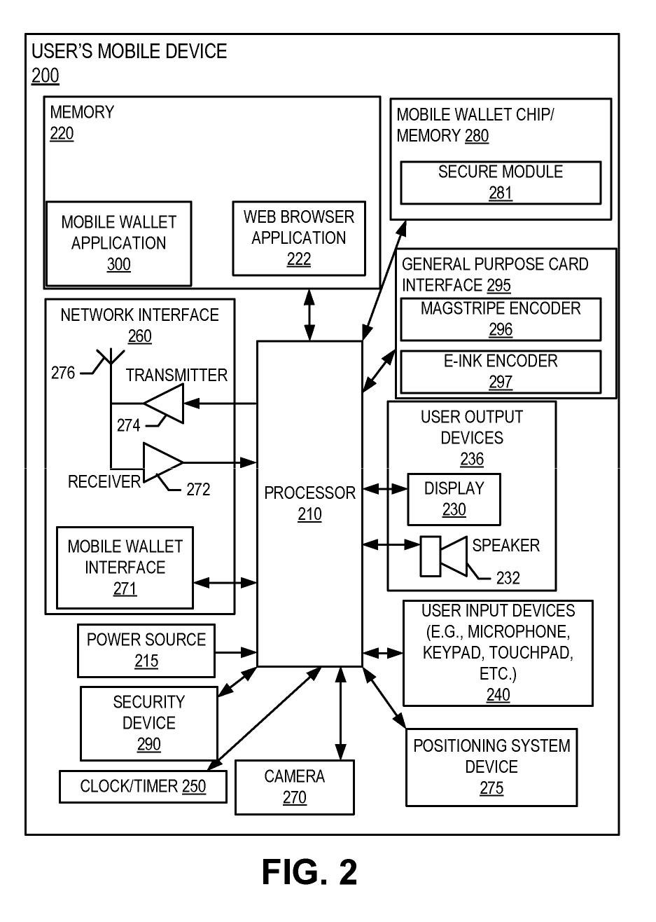

Turning now to FIG. 2, illustrated is an embodiment of a mobile device 200 that may be configured to store mobile wallet data that may be utilized to encode the general purpose card as described further below. As used herein, a “mobile device” 200 may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The mobile device 200 may generally include a processor 210 communicably coupled to such devices as a memory 220, user output devices 236, user input devices 240, a network interface 260, a power source 215, a clock or other timer 250, a camera 270, a positioning system device 275, one or more mobile wallet chips/memory 280, a security device 290, a general purpose card interface 295, etc. The processor 210, and other processors described herein, may generally include circuitry for implementing communication and/or logic functions of the mobile device 200. For example, the processor 210 may include a digital signal processor device, a microprocessor device, and various analog to digital converters, digital to analog converters, and/or other support circuits. Control and signal processing functions of the mobile device 200 may be allocated between these devices according to their respective capabilities. The processor 210 thus may also include the functionality to encode and interleave messages and data prior to modulation and transmission. The processor 210 may additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like.

The processor 210 may also be capable of operating a client application, such as a mobile wallet application 300. In one embodiment of the invention, the mobile wallet application 300 may be downloaded from a server and stored in the memory 220 of the mobile device 200. In another embodiment, the mobile wallet application 300 may be pre-installed and stored in the mobile wallet chip/memory 280. In such an embodiment, the user may not need to download the mobile wallet application 300 from a server. In some embodiments, the mobile wallet application 300 may have a graphical user interface (GUI) that allows the user to perform various processes as described below. The GUI may also allow the user to set certain payment preferences or mobile wallet preferences.

The mobile wallet chip/memory 280 may comprise one or more secure modules 281 as desired. The mobile wallet chip/memory 280 may be an integrated circuit, a microprocessor, a system-on-a-chip, a microcontroller, or the like. In one embodiment, the mobile wallet chip 280 provides Near Field Communication (NFC) capabilities to the device 200. Of note, while FIG. 2 illustrates the mobile wallet chip/memory 280 as a separate and distinct element within the mobile device 200, it will be apparent to those skilled in the art that the mobile wallet chip/memory 280 functionality may be incorporated within other elements in the mobile device 200. For instance, the functionality of the mobile wallet chip/memory 280 may be incorporated within the mobile device memory 220. In a particular embodiment, the functionality of the mobile wallet chip/memory 280 is incorporated in an element within the mobile device 200 that provides NFC capabilities to the mobile device 200. However, it is not necessary for the mobile wallet chip/memory 280 to provide the NFC capabilities to the mobile device 200. The mobile device 200 may include a NFC providing element (and/or other wireless communication systems) (not shown) separate from the mobile wallet chip/memory 280.

Module 281 may be a memory device within the mobile wallet chip/memory 280. The secure module 281 may comprise payment vehicle data associated with a plurality of payment vehicles or other vehicle data. Alternatively, the secure module 281 may comprise payment vehicle data associated with a single vehicle. The vehicle data may be data typical of standard card-type payment vehicles or other vehicles. For instance, payment vehicle data for each payment vehicle that is stored in the secure module 281 (or other modules (not shown)) may include the vehicle type, the vehicle number, the name associated with the vehicle, the expiration date of the vehicle, the CVV/CVV2 security code associated with the vehicle, whether the vehicle is a credit or debit payment vehicle, gift card payment vehicle, other vehicle, etc. Additionally, the secure module 281 may comprise data indicating whether a payment vehicle is a default payment vehicle. In the embodiment depicted in FIG. 2, since the secure module 281 is stored in a memory in the mobile wallet chip/memory 280 and not in a memory 220 in the mobile device 200, the user may be able to transfer the mobile wallet chip 280, if the mobile wallet chip 280 is not irreversibly integrated into the mobile device 200, to another mobile device and the user may consequently have access to the payment vehicles and other vehicles in the mobile wallet chip 280 on a different mobile device. Alternatively, the secure modules could be stored in secured sectors of memory 220 or other data storage of the mobile device 200 and be transferred to a new mobile device 200. Furthermore, the mobile wallet application 300 and/or data within the secure modules may be additionally stored on an external apparatus or network to provide the user 110 with the capability to readily transfer their mobile wallet system from one mobile device 200 to another or to restore their mobile wallet system to their device 200, if needed.

The processor 210 may be configured to use the network interface 260 to communicate with one or more other devices on the network 150. In this regard, the network interface 260 may include an antenna 276 operatively coupled to a transmitter 274 and a receiver 272 (together a “transceiver”). The processor 210 may be configured to provide signals to and receive signals from the transmitter 274 and receiver 272, respectively. These signals may include radio frequency signals emanating from the mobile device's transmitter 274 when the mobile device is tapped at or held or waved in close proximity to the contactless terminal 115. These signals may also include radio frequency signals received at the mobile device's receiver 272 when the mobile device 200 is tapped at or held or waved in close proximity to the contactless terminal 115. In one embodiment, these radio frequency signals may be transmitted and received in the radio frequency band, such as 13.56 MHz. In one embodiment, the ISO/IEC 14443 standard may define the protocol associated with the data carried by these radio frequency signals. In one embodiment, the transmitter 274 and receiver 272 at the mobile device may transmit and receive radio frequency signals, respectively, from a payment terminal within a distance of up to 25 cm.

As indicated earlier, the processor 210 may be configured to provide signals to and receive signals from the transmitter 274 and receiver 272, respectively. The signals may also include signaling information in accordance with the air interface standard of the applicable cellular system of the wireless telephone network that may be part of the network 150. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 200 may also be configured to operate in accordance with non-cellular communication mechanisms, such as via a wireless local area network (WLAN) or other communication/data networks.

The network interface 260 may also include a mobile wallet interface 271 in order to allow a user 110 to execute some or all of the above-described processes with respect to the mobile wallet application 300 and the secure modules 281 of the mobile wallet chip/memory 280. The mobile wallet interface 271 may have access to the hardware, e.g., the transceiver, and software previously described with respect to the network interface 260.

The mobile device 200 may comprise a transceiver that works in conjunction with the secure module 481 of the mobile device 200. In one embodiment, the antenna and other hardware or software that transmit vehicle data from the secure module 481 of the mobile device 200 may be integrated into the secure module 281.

As described above, the mobile device 200 may have a user interface that includes user output devices 236 and/or user input devices 240. The user output devices 236 may include a display 230 (e.g., a liquid crystal display (LCD) or the like) and a speaker 232 or other audio device, which are operatively coupled to the processor 210. The user input devices 240, which may allow the mobile device 200 to receive data from a user 110, may include any of a number of devices allowing the mobile device 200 to receive data from a user, such as a keypad, keyboard, touch-screen, touchpad, microphone, mouse, joystick, other pointer device, button, soft key, and/or other input device(s).

The mobile device 200 may further include a power source 215. In one embodiment, a power source 215 is a device that supplies electrical energy to an electrical load. In one embodiment, a power source 215 may convert a form of energy such as solar energy, chemical energy, mechanical energy, etc. to electrical energy. In one embodiment, a power source 215 in a mobile device may be a battery, such as a lithium battery, a nickel-metal hydride battery, or the like, that is used for powering various circuits, e.g., the transceiver circuit, and other devices that are used to operate the mobile device 200. In some embodiments, the power source 215 may be a power adapter that can connect a power supply from a power outlet to the mobile device 200. In some embodiments, a power adapter may be classified as a power source “in” the mobile device.

The mobile device 200 may also include a memory 220 operatively coupled to the processor 210. As used herein, memory may include any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory may additionally or alternatively include an electrically erasable programmable read-only memory (EEPROM), flash memory or the like.

The memory 220 may store any of a number of applications or programs which comprise computer-executable instructions/code executed by the processor 210 to implement the functions of the mobile device 200 described herein. For example, the memory 220 may include such applications as a web browser application 222 and a mobile wallet application 300. The mobile wallet application 300 may be capable of performing one or more functions described above. These applications may also typically provide a graphical user interface (GUI) on the display 230. For instance, as described previously, the GUI for the mobile wallet application 300 may allow the user 110 to enter input to select a payment vehicle or other vehicle to transmit to a contactless terminal 115 and/or encode the general purpose card 400 with the vehicle data.

The memory 220 may also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user authentication information to gain access to the mobile wallet application 300, user authentication information for each vehicle that is stored by or accessible via the mobile wallet application 300, user authentication information to access the secure modules 281 of the mobile wallet chip/memory 280, etc. In other embodiments, this authentication information may be stored in a memory of the mobile wallet chip/memory 280.

The mobile device 200 may further include a security device 290. The security device 290 serves to provide access to the user's mobile wallet (and conversely, the ability to produce encoded general purpose cards) to only authorized users. In some embodiments, the data stored on the mobile device 200, such as the mobile wallet data, may be encrypted with the signature required by the security device 290. Such encryption serves to keep sensitive data secure in the event the mobile device 200 is lost or stolen. The security device 290 can be a biometric security device that recognizes a user's fingerprint, face recognition, DNA, palm print, hand geometry, iris recognition, etc. Additionally, the security device 290 may utilize any other means known in the art, such as security codes/passwords, voice recognition, etc.

Additionally, the mobile device 200 includes a general purpose card interface 295. The general purpose card interface 295 generally serves to house the general purpose card 400 when the card 400 is not in use. The interface 295 includes a magstripe encoder 296 which is utilized to write electronic data for a selected vehicle to the magnetic stripe of the general purpose card 400. The interface further includes an electronic ink encoder 297 which is utilized to program one or more displays on the general purpose card 400 to display desired information related to the selected vehicle such as account numbers, customer's name or photo, graphics, card branding (e.g. Visa®), etc.

Of note, while FIG. 2 illustrates an electronic ink encoder 297, it will be understood that the encoder 297 may program displays other than electronic ink displays. In a preferred embodiment, the displays of the general purpose card 400 are persistent displays such as electronic ink, but other types of displays known in the art may be utilized as well. Electronic ink is a technology designed to mimic the appearance of ordinary ink on paper. Unlike conventional backlit flat panel displays which emit light, electronic ink displays reflect light like ordinary paper. Many of the technologies can hold static text and images indefinitely without using electricity, while allowing images to be changed later. Flexible electronic paper uses plastic substrates and plastic electronics for the display backplane.

Electronic ink is often considered to be more comfortable to read than conventional displays. This is due to the stable image, which has no need to be refreshed constantly, a wider viewing angle, and that it reflects ambient light rather than emitting its own light. An ideal e-ink display can be read in direct sunlight without the image appearing to fade. Full-color ability is also capable of being displayed in an electronic ink display.

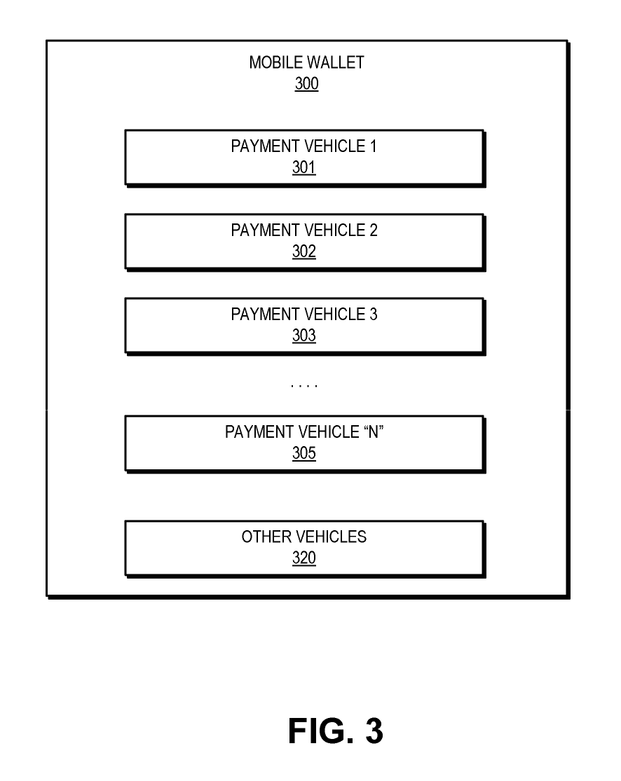

Referring to FIG. 3, a block diagram illustrating one embodiment of a mobile wallet 300 for a mobile device 200 is depicted. As illustrated, any number of payment vehicles may be contained within the mobile wallet application 300. For instance, the mobile wallet application 300 may include payment vehicle 1 301, payment vehicle 2 302, payment vehicle 3 303, and up to any number of payment vehicles “N” 305 as illustrated. “N” may be any number desired, but will generally be from 0-20, such as 1-10, and in some embodiments 1-5. Further, as illustrated in FIG. 3, the mobile wallet application 300 has the capability of including other vehicles 320 that may be any type of vehicle that is convenient to have in “card” form and may be encoded. For example, merchant loyalty cards, membership cards, rewards cards, medical cards, insurance cards, identification cards, etc. are all types of cards contemplated herein that may be encoded by the general purpose card interface 295. Any type of card identifiers may be included and encoded by the e-ink encoder 297 including alpha-numeric characters, bar codes, photographs, etc. It is also contemplated that such cards (i.e., non-payment cards) may also include data written to the magnetic stripe 450 by the magstripe encoder 296.

The mobile wallet application 300 may be configured to display a menu to the user 110 that includes selectable options for the user 110 to select which payment vehicle 305 and/or other vehicle 320 to engage in order to complete a transaction. The mobile wallet application 300 may further include any number of additional features. For instance, in one embodiment, the mobile wallet application 300 allows the user 110 to set a default payment vehicle. The mobile wallet application 300 may also provide the user 110 with information relating to the vehicles. For instance, the mobile wallet application 300 menu may include a summary of payment vehicles or other data such as rewards program information for one or more payment vehicles (e.g., cash-back benefits for using a particular payment vehicle, rewards points, etc). Furthermore, in some embodiments, the mobile wallet application 300 includes a security authorization input by the user upon initial execution of the mobile wallet application 300, such as the security device 290 discussed above. Upon authorization within the mobile wallet application 300, the user may not have to include any further security authorizations in order to access the payment vehicles and encode the general purpose card 400. Alternatively, authentication may be required prior to each general purpose card encoding.

The mobile wallet application 300 may also be configured to provide a recommendation or automatically select a vehicle for the user in specified instances. For example, external data such as geographic location, inputted user preferences, etc. may be utilized to recommend an appropriate vehicle. For instance, if the transaction terminal 115/125 is a financial institution ATM, the mobile wallet application 300 may recommend or automatically select a vehicle appropriate to transact with the ATM. In other instances, for example a transaction at a fuel station, grocery store, etc., the mobile wallet application 300 may recommend or automatically select a payment vehicle that the user has indicated they intend to use for the particular type of transaction or the mobile wallet application 300 may recommend or automatically select a payment vehicle that are enrolled in financial institution rewards programs for the particular type of transaction.

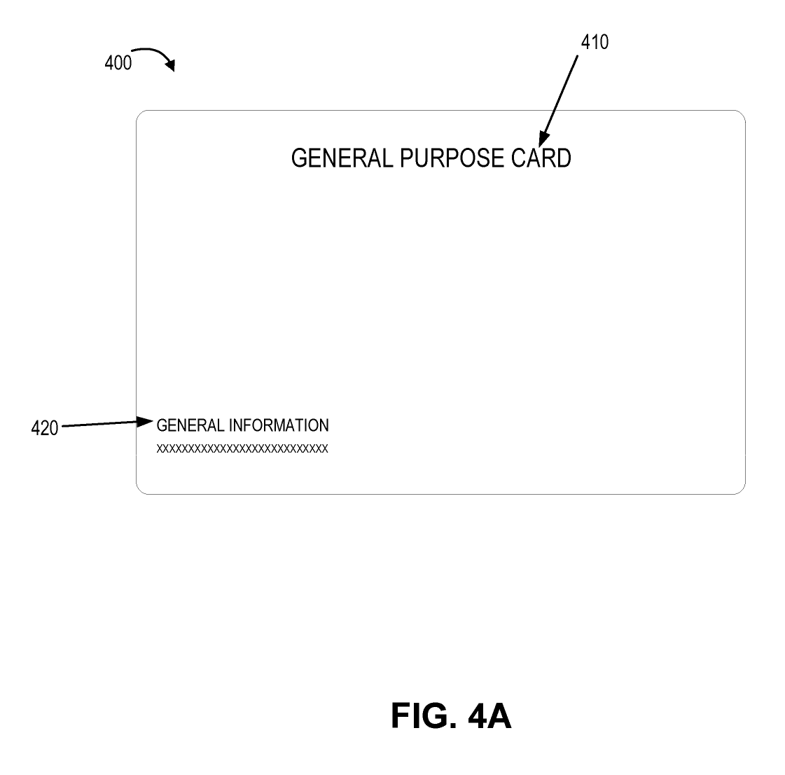

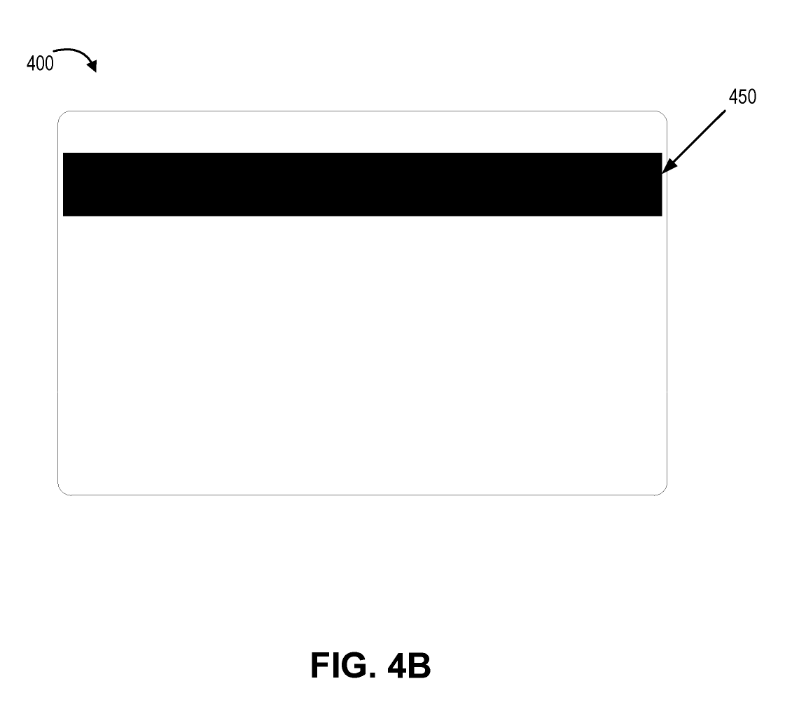

FIGS. 4A and 4B illustrate a general purpose card 400 absent electronic ink image displays 430. The card 400 looks similar to a conventional magnetic stripe card and includes magnetic stripe 450 on the back (FIG. 4B). The front side (FIG. 4A) of the card 400 may identify the card with a title 410 such as “General Purpose Card” or similar. Alternatively, the card 400 may not include a title 410. In still a further embodiment, the title 410 may be unique to each vehicle and included in one or more electronic ink image displays 430 discussed below. The front of the card may additionally include other general information 420 that may be consistent across all or most vehicles such as the financial institution issuer's name, photo, security image, etc.

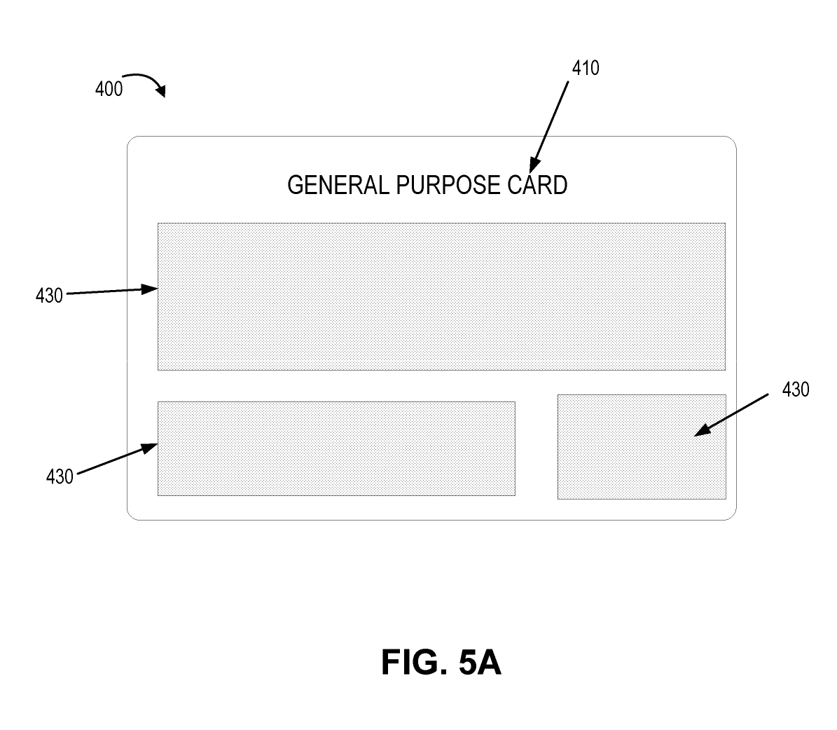

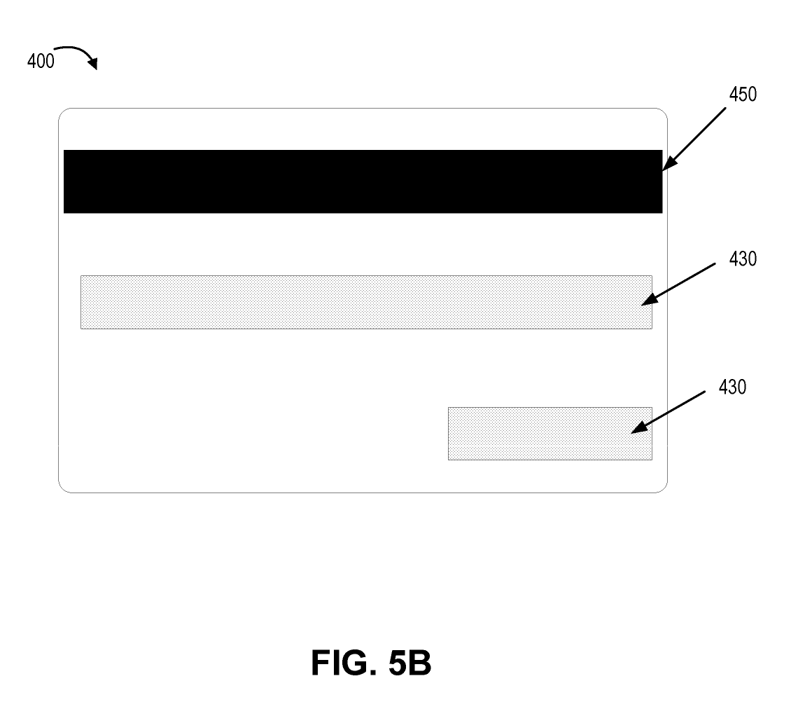

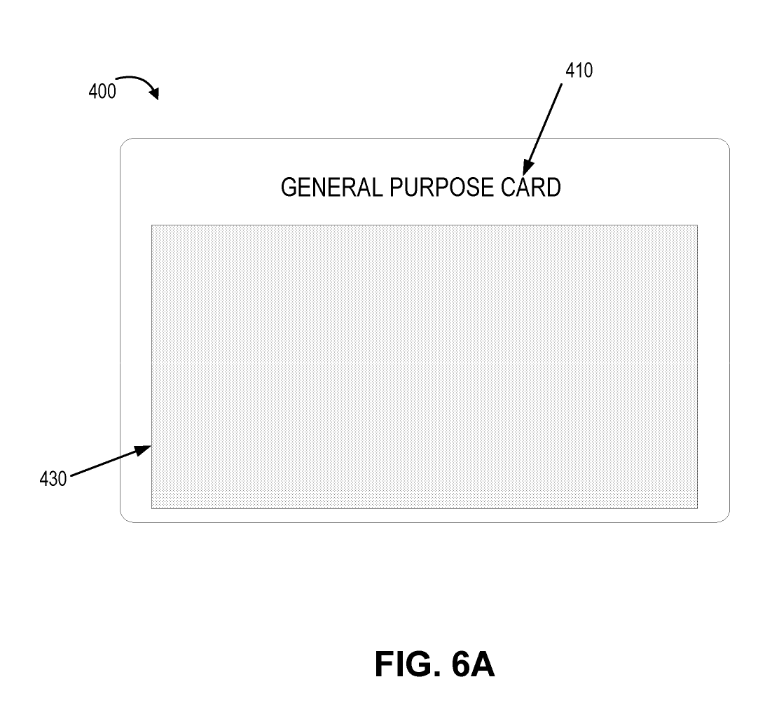

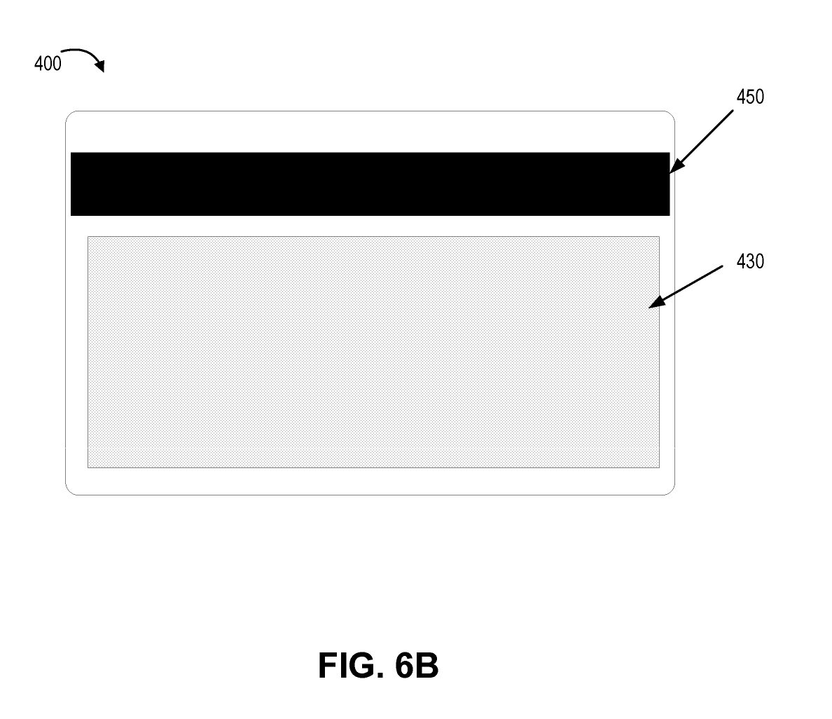

It should be noted that FIGS. 4A and 4B (as well as FIGS. 5A-6B) illustrate only some embodiments of the general purpose prepaid card 400 of the present invention. The card 100 may include less features or more features such as internal circuitry (memory, microprocessor, wireless communication device, etc.) giving the card 400 smart card functionality. In a particular embodiment, the card 400 does not include any sort of power source for the electronic ink image displays 430. As will be understood by those skilled in the art, the e-ink encoder 297 may encode the displays 430 with the desired images and the images will remain until cleared by general purpose card interface 295.

FIGS. 5A and 5B illustrate one embodiment in which the general purpose card 400 includes multiple electronic ink image displays 430 on the front (FIG. 5A) and/or the back (FIG. 5B) of the general purpose card 400. In some such embodiments, it may be desirable to have separate displays to encode rather than one large display 430 (FIGS. 6A and 6B) to encode. The data encoded by the e-ink encoder 297 may be any identifying or decorative data desirable. For example, depending on the vehicle, it may be desirable to display the issuing merchant or financial institution, user's name, unique account number, expiration date, branding (e.g., Visa®), customer service numbers, user's photograph or other identifying data, CVV/CVV2 security code, etc.

FIGS. 6A and 6B illustrate an embodiment in which the front (FIG. 6A) and/or back (FIG. 6B) of the general purpose card 400 includes a single electronic ink image display 430. In such embodiments, the entire display 430 may be encoded to display any of the type of data mentioned above. In some cases, a single display 430 may be desirable as the general purpose card 400, when encoded, may aesthetically look more uniform and less likely to be questioned as fraudulent.

In some embodiments, the general purpose card 400, after encoded, may only be capable of a single transaction or utilized at a particular merchant. For example, payment card suppliers have the ability to provide one-time use identification numbers tied to a user's account in order for the user to make a secure transaction without the worry of being victimized by fraud. Still further, the general purpose card 400, after encoded, may have an expiration time limit such that the card 400 will only yield a successful transaction for a specific period of time (e.g. less than 1 hour, less than 1 day, etc.). Furthermore, in some embodiments, the card 400 may be configured to automatically erase magnetic data written to the magnetic stripe 450 and/or alter the electronic displays 430 after a specified time period. In some embodiments, the user 110 may have the capability of wireless sending a signal to the general purpose card 400 which erases the magnetic data and/or alters the electronic displays 430. Such ability would be desirable, for instance, if the card 400 were lost or stolen after the card 400 was encoded.

In some embodiments, a user 110 may access, via the mobile device 200 the network 150 to retrieve data to be used to create a desired vehicle in card form. For example, a user 110 may purchase a prepaid card, merchant gift card, etc., receive the card data in the mobile device 200, and utilize the device to produce the physical card. Similarly, a merchant may utilize the present invention to provide a kiosk-type setup allowing customers to select and purchase prepaid cards, gift cards or even non-payment vehicles such as loyalty cards, membership cards, etc. The kiosk may essentially act as the mobile device 200 described herein and encode a general purpose card 400 and provide the card 400 to a customer. In such situations, the customer may simply discard the general purpose card 400 and/or reload the card 400 after use.

Similarly, in some embodiments, the user 110 may have a plurality of general purpose cards 400 and may encode cards for specific uses. For example, the user 400 may wish to make a payment or give money to another person. The user 110 may have the capability to produce a card 400 loaded with the desired funds and provide the card 400 to the other person.

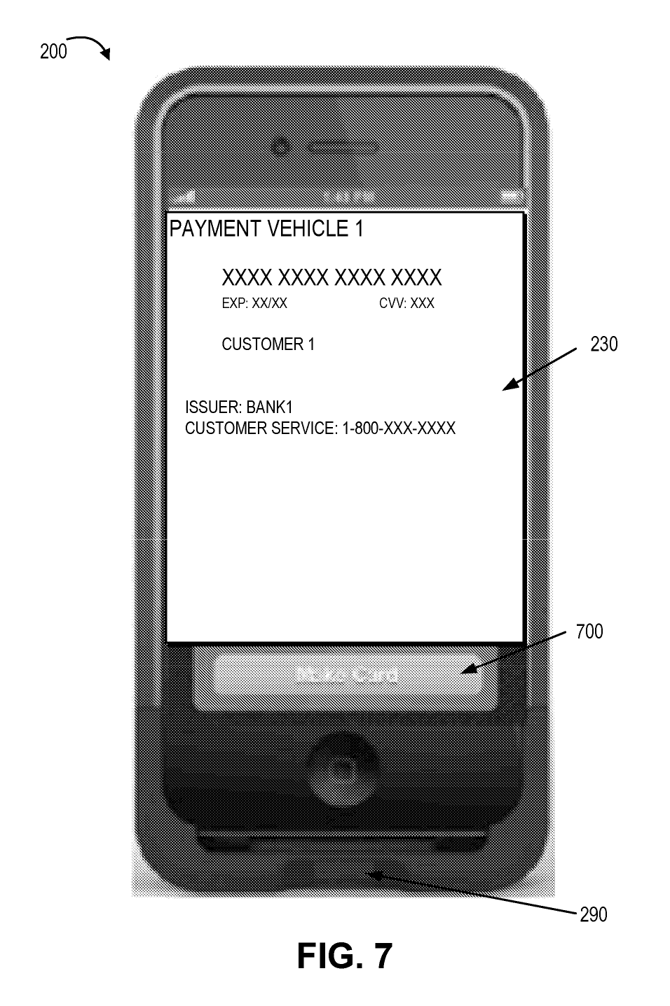

Turning now to FIG. 7, illustrated is an example embodiment of a mobile device display 230 with payment vehicle 1 301 selected. As illustrated, the mobile wallet application 300 may display any data needed or desired relating to the vehicle. In this embodiment, the payment vehicle data displayed on the mobile device display 230 includes the account number, expiration date, CVV number, user name, issuing bank and a customer service telephone number. Button 700 is included in the application to instruct the general purpose card interface 295 to “Make Card” to which the magstripe encoder 296 may write data to the magnetic strip 450 of the general purpose card 400 and the e-ink encoder 297 may generate the desired data/graphics to be displayed on the one or more displays 450 of the general purpose card 400.

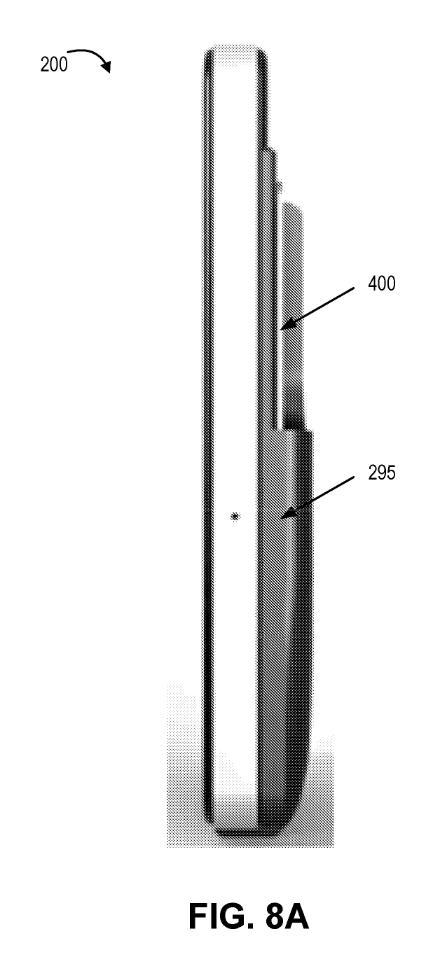

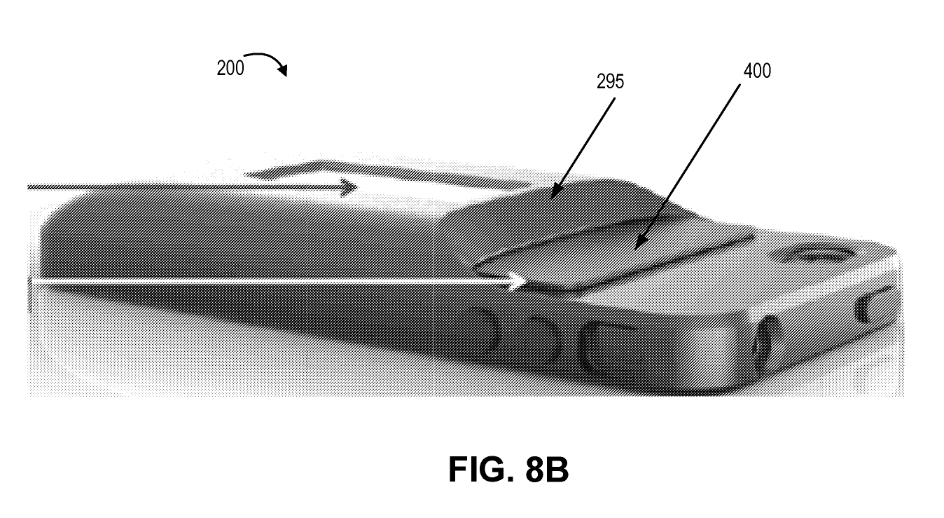

FIGS. 8A and 8B illustrate some embodiments in which the general purpose interface 295 is integrated with or removably attached to a mobile device 200. As illustrated, the general purpose card 400 may be housed in a sleeve of the general purpose interface 295. When housed in the sleeve (or returned to the sleeve), the general purpose interface may be configured to clear the data from the magnetic stripe and the electronic ink image displays 450 to be encoded for the next transaction.

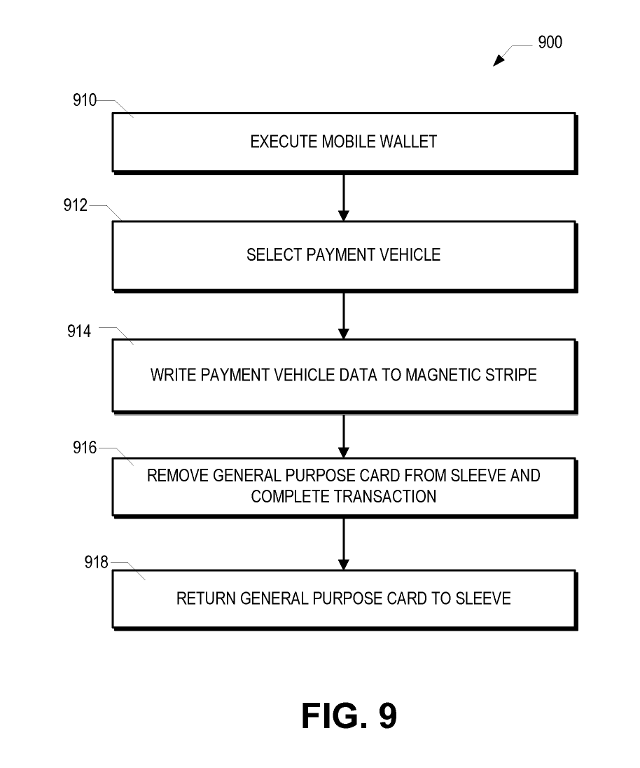

Referring now to FIG. 9, illustrated is a high level flow diagram of a method 900 for making a transaction utilizing the general purpose card 400. At block 910, the mobile wallet application 300 is executed on the mobile device 200. Executing the mobile wallet application 300 may require some degree of user authentication prior to obtaining the selection menu as described above. At block 912, a user 110 selects a desired payment vehicle (or other vehicle) from the mobile wallet. The vehicle data is then written to the magnetic stripe as illustrated at block 914. The one or more displays of the general purpose card 400 may also be programmed in this step. At block 916, the user 110 removes the general purpose card 400 from the mobile device 200 in order to conduct the transaction. Upon returning the general purpose card 400 to the mobile device 200, as illustrated at block 918, the magnetic data may be erased from the general purpose card 400 and the displays 430 may be altered to a generic state to await the next encoding.

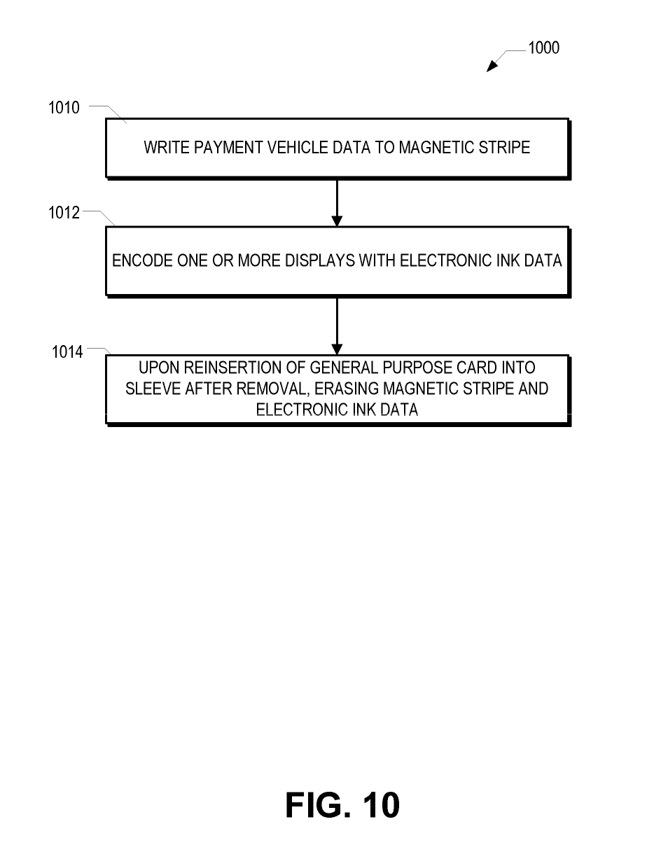

At FIG. 10, illustrated is another high level flow diagram of a method 1000 for making a transaction utilizing the general purpose card 400. At block 1010, the payment vehicle data (or other vehicle data) may be written to the magnetic stripe of the general purpose card 400. One or more displays 430 may be encoded with electronic ink data as indicated at block 1012. At block 1014, upon reinsertion of the card 400 into the general purpose card interface 295, the magnetic stripe 450 and electronic ink displays 430 may be returned to their default state.

Thus, present embodiments of the invention disclosed in detail above provide systems, methods, and computer program products for a mobile device with a rewritable general purpose card. The mobile device includes a mobile wallet accessible to the user such that the user may select a payment vehicle (e.g., debit card, credit card, gift card, etc.) or other vehicle (e.g., merchant loyalty cards, membership cards, rewards cards, medical cards, insurance cards, identification cards, etc.) and encode data related to that vehicle to the rewritable general purpose card. The user may then utilize the encoded general purpose card to make a transaction. Generally, the general purpose card includes one or more displays which may be configured to display information, graphics, data, etc. (e.g. account number, expiration date, user identification such as name and/or photograph, card brand logo, bar codes or other codes readable to an electronic device, etc.).

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A mobile device for configuring a general purpose transaction card comprising a magnetic stripe and a plurality of electronic displays on one face of the general purpose transaction card, the mobile device comprising:
a memory device;
a user interface configured to present information to a user; and
a processing device operatively coupled to the memory device and the user interface, wherein the processing device is configured to execute computer-readable program code to:
display, via the user interface, one or more transaction vehicles in an electronic mobile wallet, the one or more transaction vehicles being selectable to the user;
receive a transaction vehicle selection from the user;
encode data related to the selected vehicle onto a magnetic stripe of a general purpose transaction card, wherein the general purpose transaction card is separate from the mobile device; and
configure each of the plurality of electronic displays on the one face of the general purpose transaction card to display information related to the selected transaction vehicle including, at least, a card verification value (CVV) of the selected transaction vehicle.

2. The mobile device of claim 1, further comprising a general purpose transaction card interface that houses the general purpose transaction card, the general purpose transaction card interface including a magnetic stripe encoder for encoding the data onto the magnetic stripe of the general purpose transaction card and an electronic display encoder for programing the plurality of electronic displays of the general purpose transaction card.

3. The mobile device of claim 1, wherein the plurality of electronic displays comprise persistent displays.

4. The mobile device of claim 3, wherein the plurality of electronic displays comprises electronic ink displays.

5. The mobile device of claim 1, wherein the general purpose transaction card does not include a power source.

6. The mobile device of claim 1, further comprising a biometric security device.

7. The mobile device of claim 1, wherein the processing device is further configured to execute computer-readable program code to reset the general purpose transaction card erasing magnetic data encoded on the magnetic stripe and altering the plurality of electronic displays.

8. The mobile device of claim 7, wherein the resetting of the general purpose transaction card is completed upon returning of the general purpose card to the mobile device.

9. The mobile device of claim 1, wherein the one or more transaction vehicles comprise payment vehicles.

10. The mobile device of claim 1, wherein the one or more transaction vehicles comprise non-payment transaction vehicles selected from the group comprising merchant loyalty cards, membership cards, rewards cards, medical cards, insurance cards, and identification cards.

11. A method for configuring a general purpose transaction card comprising a magnetic stripe and a plurality of electronic displays on one face of the general purpose transaction card, the method comprising:
executing, by a processing device of an electronic mobile device, an electronic mobile wallet comprising one or more transaction vehicles selectable to a user;
encoding data related to a user-selected transaction vehicle onto the magnetic stripe of the general purpose transaction card; and
configuring each of the plurality of electronic displays on the general purpose transaction card to display information related to the selected transaction vehicle including, at least, a card verification value (CVV) of the selected transaction vehicle.

12. The method of claim 11, wherein the mobile device comprises a general purpose transaction card interface that houses the general purpose transaction card, the general purpose transaction card interface including a magnetic stripe encoder for encoding the data onto the magnetic stripe of the general purpose transaction card and an electronic display encoder for programing the plurality of electronic displays of the general purpose transaction card.

13. The method of claim 11, wherein the one or more electronic displays comprise electronic ink displays.

14. The method of claim 11, further comprising resetting the general purpose transaction card erasing magnetic data encoded on the magnetic stripe and altering the plurality of electronic displays.

15. The method of claim 11, wherein the one or more vehicles comprise non-payment transaction vehicles selected from the group comprising merchant loyalty cards, membership cards, rewards cards, medical cards, insurance cards, and identification cards.

16. A method for performing, using a general purpose card comprising a magnetic stripe and a plurality of electronic displays on one face of the general purpose transaction card, a transaction comprising:
selecting a transaction vehicle from an electronic mobile wallet of a mobile device, wherein upon selecting the transaction vehicle, the mobile device encodes data related to the selected transaction vehicle onto the magnetic stripe of the general purpose transaction card and configures each of the plurality of electronic displays on the one face of the general purpose transaction card to display information related to the selected transaction vehicle including, at least, a transaction vehicle type, wherein the transaction vehicle type includes any one or a combination of a credit card, a debit card, a loyalty card, a membership card, a rewards cards, a medical card, or an insurance card;
removing the general purpose transaction card from the mobile device;
utilizing the general purpose transaction card to perform the transaction; and
returning the general purpose transaction card to the mobile device.

17. The method of claim 16, wherein the mobile device comprises a general purpose transaction card interface that houses the general purpose transaction card, the general purpose transaction card interface including a magnetic stripe encoder for encoding the data onto the magnetic stripe of the general purpose card and an electronic display encoder for programing the plurality of displays on the face of the general purpose transaction card.

18. The method of claim 16, wherein the plurality of electronic displays on the face comprises electronic ink displays.

19. The method of claim 16, wherein the one or more vehicles comprise non-payment transaction vehicles selected from the group comprising merchant loyalty cards, membership cards, rewards cards, medical cards, insurance cards, and identification cards.

20. A computer program product comprising a non-transitory computer-readable medium comprising instructions for a processing device of a mobile device for configuring a general purpose transaction card comprising a magnetic stripe and a plurality of electronic displays on one face of the general purpose transaction card, when the instruction are executed by the processing device causes the mobile device to:
execute an electronic mobile wallet application comprising one or more transaction vehicles selectable to a user;
encode data related to a selected transaction vehicle onto the magnetic stripe of the general purpose transaction card; and
configure each of the plurality of electronic displays on the one face of the general purpose transaction card to display information related to the selected transaction vehicle including, at least, a card verification value (CVV) of the selected transaction vehicle.

21. The computer program product of claim 20, wherein the mobile device comprises a general purpose transaction card interface that houses the general purpose transaction card, the general purpose transaction card interface including a magnetic stripe encoder for encoding the data onto the magnetic stripe of the general purpose transaction card and an electronic display encoder for programing the plurality of displays on the face of the general purpose transaction card.

22. The computer program product of claim 20, wherein the plurality of electronic displays on the face of the general purpose card comprise electronic ink displays.

23. The computer program product of claim 20, further comprising instructions for a processing device of a mobile device to reset the general purpose transaction card erasing magnetic data encoded on the magnetic stripe and altering the plurality of electronic displays on the face of the general purpose card.

24. The computer program product of claim 20, wherein the one or more vehicles comprise non-payment transaction vehicles selected from the group comprising merchant loyalty cards, membership cards, rewards cards, medical cards, insurance cards, and identification cards.

25. The mobile device of claim 1, wherein at least one of the plurality of electronic displays is further configured to information related to the selected transaction vehicle comprising an expiration data.

26. The method of claim 11, wherein the information related to the selected transaction vehicle displayed via each of the plurality of electronic displays of the general purpose transaction card includes any one or more of an account number, a customer name, a customer photo, a graphic, an issuing institution, a customer service telephone number, an expiration date, a user name, a transaction vehicle type, or a card branding.

27. The computer program product of claim 20, wherein information related to the selected transaction vehicle shown via each of the plurality of electronic displays of the general purpose transaction card includes any one or more of an account number, a customer name, a customer photo, a graphic, an issuing institution, a customer service telephone number, an expiration date, a user name, a transaction vehicle type, or a card branding.
